(19) United States
(12) Patent Application Publication
(10) Pub. No.: US 2004/0034138 A1
(43) Pub. Date: Feb. 19, 2004

(54) Salt-sensitive polymer composition

(76) Inventors: Richard Buscall, Thirsk (GB); Martin W. Murray, Cleveland (GB); Dongyun Huang, Bridgewater, NJ (US); John F. Jennings, Middlesbough (GB)

Correspondence Address: Thomas F. Roland, NATIONAL STARCH AND CHEMICAL COMPANY, P.O. Box 6500, Bridgewater, NJ, 08807-0500, US

(21) Appl. No.: 10/418,356

(22) Filed: Apr. 16, 2003

Related U.S. Application Data
(60) Provisional application No. 60/374,368, filed on Apr. 19, 2002.

(51) Int. Cl. C08L 1/00

(52) U.S. Cl. 524/377

(57) ABSTRACT

A salt-sensitive film-forming polymer composition is presented. The salt-sensitivity of the film is produced by the combination of the polymer and at lest one salt-sensitive adjuvant that affects the properties of the film. The film has integrity in an aqueous solution containing 0.5 weight percent or more of an inorganic salt, yet in water the adjuvant dissolves, causing the polymer film to lose integrity. The polymer composition may be used in applications requiring a salt-trigger, such as flushable non-woven products, and triggerable delivery systems for a variety of materials such as in detergents.

This application claims the benefit of U.S. Provisional Application No. 60/374,368 filed Apr. 19, 2002.

### FIELD OF THE INVENTION

This invention relates to film-forming polymer compositions that are salt-sensitive. The salt-sensitivity of the film is produced by the combination of the polymer and at lest one salt-sensitive adjuvant that affects the properties of the film. The film has integrity in an aqueous solution containing 0.5 weight percent or more of an inorganic salt, yet in water the adjuvant dissolves, causing the polymer film to lose integrity. The polymer composition may be used in applications requiring a salt-trigger, such as flushable non-woven products, and triggerable delivery systems for a variety of materials such as in detergents.

### BACKGROUND OF THE INVENTION

Salt-triggerable polymers are polymers that are soluble or dispersible in water, yet non-soluble or non-dispersible in a solution having a certain level of ionic strength. One application for this type of polymer is as a binder for a non-woven, in which the binder remains intact when dry, or in contact with a salt-containing fluid (such as body fluid), yet the binder dissolves or disperses in water, allowing one to flush the soiled non-woven article into a sewer or septic system.

U.S. patent application Ser. Nos. 09/540,033 and 09/823,318 describe salt sensitive aqueous emulsions which form films that are water-dispersible, yet non-dispersible in aqueous solutions containing 0.5 percent or more of an inorganic salt. U.S. Pat. Nos. 5,509,913 and 6,127,593 disclose flushable fibrous articles with solubility related to salt concentration. U.S. Pat. No. 5,935,880 discloses dispersible non-woven fabric and a method for making the fabric. The binder dissolves in water at less than 50 parts per million (ppm) of divalent ions, allowing for the non-woven material to be broken and dispersed in water.

One drawback of the current technology is that specific polymers must be tailored during the polymerization process to achieve the salt-sensitive property. In many cases the process for polymerization of these polymers is time consuming and expensive, and may be applicable only to certain types of polymers. There is a need for a process that can add a salt-sensitive trigger to a polymer, that process being simple to apply to a wide range of polymer types.

Surprisingly it has been found that a polymer composition combining a polymer, a salt-sensitive adjuvant that is known to effect the film properties of the polymer, can produce salt-triggerable polymer films. This process provides flexibility to tailor the polymer system to the conditions of the end-use application. The novel step is not so much that a water-soluble adjuvant can migrate out of a film when placed in water, but rather that film properties can be controlled in solutions of varying ionic strength by designing a system where the migration of the adjuvant is triggered by changes in ionic strength. This control of the adjuvant migration can be used to trigger catastrophic failure in film properties.

### SUMMARY OF THE INVENTION

The present invention is directed to a polymer composition comprising

a) a polymer; and

b) at least one water-soluble, salt-sensitive adjuvant that is added to the polymer, wherein

said adjuvant affects the properties of a film formed from the emulsion polymer, wherein said polymer composition is film-forming, and wherein a film formed from said emulsion polymer has integrity in an aqueous solution containing 0.5 weight percent or more of an inorganic salt, yet loses integrity in water due to the dissolution of the water-soluble adjuvant.

The invention is also directed to a process for triggering a loss of integrity in a polymer film comprising the steps of

a) forming a polymer;

b) combining with said polymer at least one water-soluble, salt-sensitive adjuvant to form a salt-sensitive polymer composition, wherein said adjuvant affects the properties of a film formed from the emulsion polymer, wherein said polymer composition is film-forming, and wherein a film formed from said emulsion polymer has integrity in an aqueous solution containing 0.5 weight percent or more of an inorganic salt, yet loses integrity in water due to the dissolution of the water-soluble adjuvant;

c) contacting said polymer composition with a substrate, and drying said polymer composition to form a film on said substrate;

d) associating said polymer film with an aqueous environment containing at least 0.5 weight percent of salt, wherein said film maintains its integrity; and

e) placing said polymer film in water, wherein said polymer film loses its integrity.

The loss of polymer integrity may be catastrophic—resulting in the polymer film failing to perform its intended function.

### BRIEF DESCRIPTION OF THE DRAWINGS

FIG. 1 is a plot of the results of Example 3, showing the level of plasticizer leeching in water for a low molecular weight polymethylmethacrylate (PMMA) film plasticized with various plasticizers.

FIG. 2 is a plot of the results of Example 4, showing the level of plasticizer leeching in water for a high molecular weight polymethylmethacrylate film plasticized with various plasticizers.

FIG. 3 is a plot of the results of Example 5, showing the level of plasticizer leeching in water for an isobornylmethacrylate/methylmethyacrylate copolymer film plasticized with various plasticizers.

FIG. 4 is a plot of the results of Example 6, showing the level of plasticizer leeching in water for a styrene/methylmethyacrylate copolymer film plasticized with various plasticizers.

FIG. 5 is a plot of the results of Example 7, showing the level of plasticizer leeching in water for an styrene/methylmethyacrylate copolymer film plasticized with various plasticizers.

FIG. 6 is a plot of the results of Example 8, showing the level of plasticizer leeching in water for an polyvinylacetate film plasticized with various plasticizers.

FIG. 9 is a plot of the results of Example 10, showing the level of plasticizer leeching in water for a polymethylmethacrylate film plasticized with various plasticizers.

### DETAILED DESCRIPTION OF THE INVENTION

The present invention relates to film-forming polymer compositions containing at least one water-soluble, salt-triggerable adjuvant that affects the properties of the film. Polymer films formed from the polymer composition have integrity in an aqueous solution containing 0.5 weight percent or more of a salt, yet in water the adjuvant dissolves, causing the polymer film to lose integrity.

The polymer composition comprises at least one polymer, and at least one adjuvant added to the polymer, before, during or after polymerization, to form a polymer composition.

The polymer can be any polymer having any composition or architecture, and may be formed by any known process. The polymer may be a natural or synthetic polymer. Aqueous polymer systems are preferred, with emulsion polymers being most preferred. It is an objective of the invention to employ a salt-sensitive adjuvant that can be combined with many different types of polymers, in order to overcome problems found in present salt-sensitive polymers that require special polymerization techniques or special monomers. The polymer can be a homo-polymer, a copolymer or terpolymer, and can be of any polymer architecture—including random, block, or star polymers. The polymer should be capable of being made film-forming through the use of plasticizers and other known means. The final composition including the polymer and additives will be film-forming. If the polymer is an emulsion polymer, it can be made by known processes, such as batch, semi-batch, and continuous processes. The reactants may be all added at the start of the reaction, or one or more components of the emulsion may be delay-fed into the reaction. Monomers, including function monomers could be incorporated into the polymer as known in the art, depending on the end-use of the polymer. These include adhesion promoting monomers, such as acrylic acid; cross-linking monomers, anionic and cationic monomers.

The salt-sensitive water-soluble adjuvant is one that affects the physical properties of the film. For an adjuvant to be useful in the present invention, it must be able to salt-out of solution at higher ionic strengths. It must also be water soluble, and be able to leech-out of the polymer film in a short time period. Adjuvants useful in the invention are able to obtain at least 60 percent leech-out from the polymer film in 25° C. D.I. water in 90 minutes or less. It has been found that not all adjuvants which salt-out are able to leech-out of the polymer within this time frame. The adjuvant must have some effect on a film formed from the emulsion polymer, such that without the adjuvant the film loses its integrity and can no longer function in its intended use.

Examples of such adjuvants include, but are not limited to, plasticizers, adhesion promoters, tackifiers, pigment and fillers, and anti-plasticizers. A surfactant could be used if it also functioned in an additional mode—such as a plasticizer. It has been found that surfactant-plasticizers work better if cured at lower temperatures, as they can lose their trigger if cured at higher temperature. The plasticizer may also have other functions, for instance as a humectant. The amount and type of adjuvant used can be varied to meet the requirements for the use of the polymer. The adjuvant may affect the modulus, Tg, extension to break, adhesive properties, surface energy, flow, creep, and optical clarity.

As an example, polyethylene glycol itself would not normally be included within the invention, since it is soluble in both water and most saline solutions so it would not salt-out. However, many higher alkylene glycols and glycol derivatives that are more hydrophobic would meet the requirements for use in the invention. These include copolymers of polyethylene glycol and polybutylene glycol or polypropylene glycol. While not being bound to any theory, it is believed that this behavior is related to the larger hydrophilic blocks which may hinder the ability to salt out. It is also possible that under the proper conditions even polyethylene glycol may salt-out, as in the presence of some sulfate or phosphate salts.

The trigger point for the solubility of the adjuvant, and thus the loss of integrity of the polymer film, can be adjusted somewhat depending on the molecular structure of the adjuvant. In general, the adjuvant will be soluble in water, yet will salt-out and be insoluble in aqueous solutions containing 0.5 weight percent of salt, more preferably at least 1 percent by weight salt. The salt may be an inorganic salt, organic salt, or a mixture of one or more salts. It may be a mono-, di-, or tri-valent salt, of mixture thereof. It has been found that solubility/salt-out effects can be altered somewhat based on the counter anion present.

The polymer and adjuvant may be combined by means known in the art. Since the adjuvant is water-soluble, it can easily be blended with aqueous polymer systems like emulsions. The adjuvant may be added to the polymer at any point—pre-polymerization, during the polymerization, or post polymerization. Generally, the adjuvant is added to the emulsion after polymerization. The amount of the adjuvant added will depend on the intended effect required in the final film. Generally from 1 to 300 parts of the adjuvant are added per 100 parts of polymer solids on a weight/weight basis. A preferred ratio is from 5 to 200 parts adjuvant to 100 parts polymer solids.

Films formed from the polymer composition maintain their integrity in aqueous solutions containing at least 0.5 weight percent of a salt. This is because the adjuvant is insoluble in the salt solution, thus it remains in the film and affects the film properties—and thus film integrity. When the salt concentration is lowered, the adjuvant becomes soluble and leaves the film. The polymer film then loses the property or properties contributed by the adjuvant, and this results in loss of film integrity. The loss of film integrity can be of several forms, and can have a catastrophic effect on film. Several examples will illustrate the effect caused by the loss of film integrity.

In the case where the salt-sensitive adjuvant is a plasticizer, the plasticizer acts to lower the Tg of the polymer composition. An example would be a polyalkylene oxide derivative as a plasticizer for a high Tg acrylic polymer. In this case the polymer may have a Tg of greater than 80° C., or even greater than 100° C. for use as a binder. The addition of the plasticizer will lower the Tg making the polymer composition useful, for example, as a binder for a non-woven material. When the non-woven is in contact with an aqueous liquid having an ionic strength greater than 0.5 percent, the plasticizer remains insoluble, and the film Tg remains flexible. If the non-woven is placed in water, the plasticizer becomes soluble and leaves the polymer film. This raises the Tg of the film to produce a brittle polymer that will break into smaller pieces, allowing the non-woven to be dispersible. This type of polymer composition would be useful in producing diapers, feminine hygiene, and other articles that would maintain integrity when soiled, yet lose integrity and be dispersible in water—allowing the articles to be disposed of by flushing down the toilet. The same mechanism would work where the polymer is used to coat or encapsulate a detergent or fabric softener component. The film would maintain integrity in the laundry or dishwasher wash cycle having higher ionic strength, yet the film would lose integrity and disperse in the rinse cycle having a lower ionic strength.

In the case of a tackifier or adhesion promoter, the adhesion promoter allows a film to adhere to a substrate. The adhesion promoter remains in the polymer at higher ionic strength, yet dissolves into water, thus decreasing the adhesion between the film and a substrate resulting in failure. This mechanism could also be used in a non-woven, in which the polymer film adheres to fibers due in part to the adhesion promoter at higher ionic strength. In water, the adhesion promoter leaves the polymer film, and though the film remains intact, the attachment to the substrate fails—allowing the non-woven to disperse and be flushable.

The leeching of many types of adjuvants can result in the formation of pores or holes in the polymer film. This decreases the integrity of the film by making it weaker and more prone to failure by many modes. If the film were used as an encapsulant for small molecules—such as dyes or fragrances—formation of pores in the film upon leeching of the adjuvants in water could allow the small molecules to migrate through the pores and into the aqueous solution.

Films may be formed by applying the polymer composition to a substrate and drying the composition. The polymer may be applied to the substrate by known means such as spraying, immersion, and brushing; and may be dried by known means such as oven, hot air, drum drying, IR, or microwave. In one embodiment the drying temperature is above the Tg of the polymer. It is believed that this allows a plasticizer to penetrate the interior of a film formed from an emulsion polymer, and thereby lower the Tg of the film. In another embodiment the drying temperature may be below the Tg of the polymer. It is possible that the polymer Tg and drying temperature is related to the molecular weight of the plasticizer, with lower molecular weight plasticizers being able to more effectively migrate into the polymer film at any temperature, with the migration of higher molecular weight plasticizers benefiting from drying temperature above the polymer Tg.

Salt-sensitive films of the emulsion composition may be used as coatings, encapsulants, binders and adhesives in a variety of end-use applications, including, but not limited to, non-woven binders, especially flushable applications; controlled-release delivery systems—such as for laundry and dish washer applications; oil field applications; agrochemical such as for seed coatings, coatings for fertilizer that releases when watered, and for weed killers; temporary coatings for metals and other substrates that can be removed with water; fugitive binders for ink or toner; a coating for clothing to resist penetration of sweat, but be removable in water; shampoo containing encapsulated conditioner for release during rinse.

The following examples are presented to further illustrate and explain the present invention and should not be taken as limiting in any regard.

### EXAMPLE 1

A 50/50 weight blend based on solids, of polymethylmethacralate (PMMA) and Synperonic NP8, a nonyl phenol ethoxylate from Uniqema, was used to prepare a film. The PMMA was in aqueous emulsion with 30 percent solids. The number average molecular weight ranged from 25,000 to 35,000 by GPC. The mixture of PMMA emulsion and NP8 was dried at ambient temperature, and then in 50° C. oven for one hour. The film was clear and flexible, with roughly 1.0 mm in thickness. It was stored in a desiccator. A square piece (−1.0×1.0 cm) was cut and soaked in deionized water and 2M MgSO₄ solution respectively for 120 minutes. After this period the level of NP8 leeched from the film was determined by gravimetric analysis. No significant leeching occurred from the film soaked in MgSO₄ solution, and only 7 percent of the NP8 leeched from the film soaked in DI water. The soaked films from both liquids remained clear and flexible, similar physical characteristics to unsoaked film specimen.

### EXAMPLE 2

A 50/50 weight blend based on solids of the PMMA of Example 1 and a block copolymer of 50/50 ethylene oxide and propylene oxide based on weight with a molecular weight of 2000, was used to prepare a film. The film preparation method was the same as Example 1. The film was soaked in Di water and 2M MgSO4₄ solution respectively for 120 minutes. After this period the level of ethylene oxide/propylene oxide leeched from the film was determined by gravimetric analysis. The film soaked in MgSO₄ solution gave an insignificant leeching of 4 percent. The film soaked in Di water leeched 47 percent of polyethylene oxide/propylene oxide copolymer. The MgSO4 soaked film remained clear and flexible. The DI water soaked film became opaque and brittle.

### EXAMPLE 3

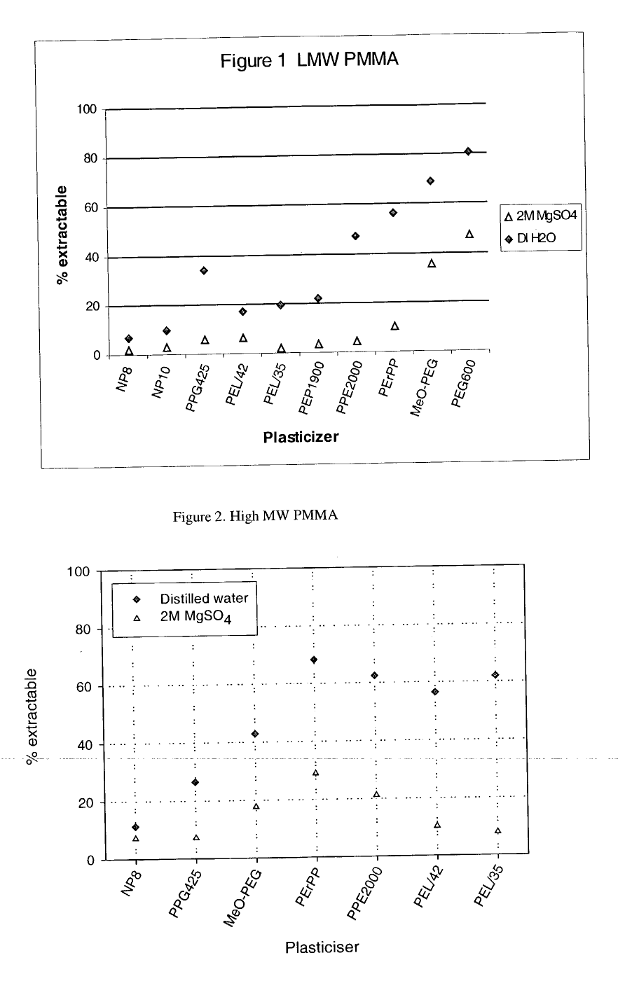

Blends of the PMMA of Example 1 and various plasticizers (polyethylene glycol derivatives) were made at 50/50 weight ratio. They were then made into films, as in Example 1. The description of plasticizers is given in Table I. The liquid blends were then made into films, as in Example 1. The films were cut into 1.0×1.0 cm square specimens, and soaked for 120 minutes in deionized water and 2M MgSO₄ solution, respectively. Then the leeching of plasticizer was determined by gravimetric analysis. The results are shown in Table II and FIG. 1.

TABLE I
Description of polyethylene glycol derivatives used as plasticizers

| Plasticizer | Description | Supplier | Avg. MW | EO content | |
|---|---|---|---|---|---|
| Syperonic | nonyl phenol | Uniqema | ˜600 | 8 | units |
| NP8 | ethoxylate | | | | |
| Syperonic | nonyl phenol | Uniqema | ˜700 | 10 | units |
| NP10 | ethoxylate | | | | |
| Syperonic | PEG/PPG block | Uniqema | 1,900 | 50 | wt % |
| PEL/35 | copolymer | | | | |
| Syperonic | PEG/PPG block | Uniqema | 1,650 | 20 | wt % |
| PEL/42 | copolymer | | | | |
| PEP1900 | PEG/PPG/PEG block | Aldrich | 1,900 | 50 | wt % |
| | copolymer | | | | |
| PPE2000 | PPG/PEG/PPG block | Aldrich | 2,000 | 50 | wt % |
| | copolymer | | | | |
| PEG600 | Poly(ethylene glycol) | Aldrich | 600 | 100 | wt % |
| PEG1000 | Poly(ethylene glycol) | Aldrich | 1,000 | 100 | wt % |
| PPG425 | Poly(propylene glycol) | Aldrich | 425 | 0 | wt % |
| MeO-PEG | Methoxyl terminated | Aldrich | 2,000 | ˜100 | wt % |
| | poly(ethylene glycol) | | | | |
| PErPP | PEG-PPG random | Aldrich | 2,500 | 75 | wt % |
| | copolymer | | | | |

TABLE II

% extractable

| Plasticizer | 2M MgSO₄ | DI H₂O |
|---|---|---|
| NP8 | 1.8 | 6.9 |
| NP10 | 2.9 | 9.7 |
| PPG425 | 5.8 | 34 |
| PEL/42 | 6.2 | 16.9 |
| PEL/35 | 2.0 | 19.4 |
| PEP1900 | 3.5 | 21.8 |
| PPE2000 | 4.4 | 47.2 |
| PErPP | 10.2 | 56.3 |
| MeO-PEG | 35.3 | 68.8 |
| PEG600 | 47.3 | 80.5 |

### EXAMPLE 4

A high MW PMMA was prepared in aqueous emulsion at 30 percent solids. The Mn was measured as about 985,000. Blends of the high MW PMMA, and various plasticizers were made at 50/50 weight ratio. They were then made into films, as in Example 1. The films were cut into 1.0×1.0 cm square specimens, and soaked for 120 minutes in deionized water and 2M MgSO₄ solution, respectively. Then the leeching of plasticizer was determined by gravimetric analysis. The results are shown in Table Ill and FIG. 2.

TABLE III

% extractable

| Plasticizer | 2M MgSO₄ | DI H₂O |
|---|---|---|
| NP8 | 7.2 | 11.3 |
| PPG425 | 7.2 | 26.5 |
| PEL/42 | 10.2 | 56.4 |
| PEL/35 | 7.9 | 61.9 |
| PPE2000 | 21.2 | 62.4 |
| PerPP | 29.0 | 68.2 |
| MeO-PEG | 17.7 | 42.9 |

### EXAMPLE 5

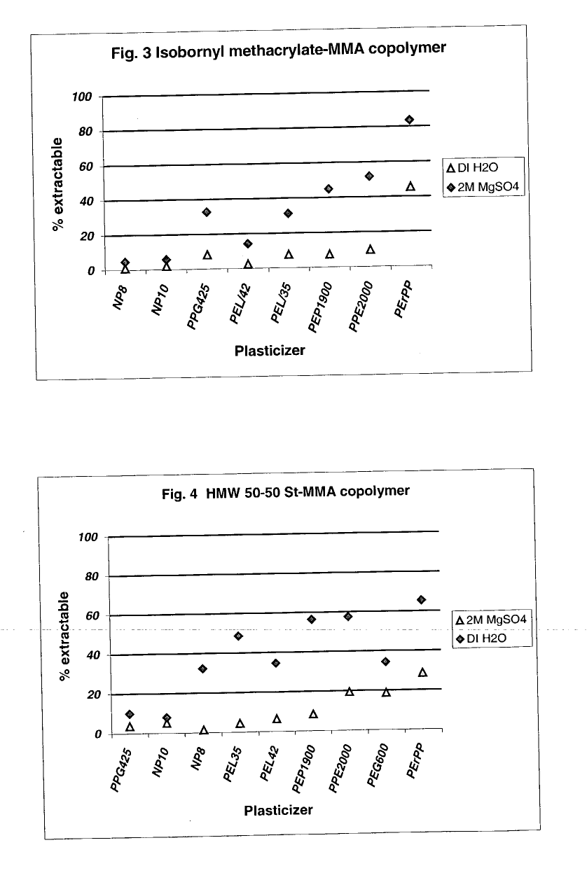

A 50/50 iso-bornyl methacrylate/methyl methacrylate (iso-bM/MMA) polymer was prepared in aqueous emulsion with about 40 percent solids. The molecular weight (Mn) was measured as about 35,000 by GPC. Blends of poly(iso-bM/MMA) and various plasticizers were made at 50/50 weight ratio. They were then made into films, as in Example 1. The films were cut into 1.0×1.0 cm square specimens, and soaked for 120 minutes in deionized water and 2M MgSO₄ solution, respectively. Then the leeching of plasticizer was determined by gravimetric analysis. The results are shown in Table IV and FIG. 3.

TABLE IV

% extractable

| Plasticizer | 2M MgSO₄ | DI H₂O |
|---|---|---|
| NP8 | 0.9 | 4.6 |
| NP10 | 2.0 | 5.8 |
| PPG425 | 8.2 | 32.7 |
| PEL/42 | 2.4 | 14.2 |
| PEL/35 | 7.7 | 31.3 |
| PEP1900 | 7.4 | 44.9 |
| PPE2000 | 9.7 | 51.7 |
| PErPP | 45.4 | 83.6 |

### EXAMPLE 6

A 50/50 styrene/methyl methacrylate (St/MMA) copolymer was prepared in aqueous emulsion with about 35 percent solids. The molecular weight (Mn) was measured at about 15,000 by GPC. Blends of poly(St/MMA) and various plasticizers were made at 50/50 weight percent. They were then made into films, as in Example 1. The films were cut into 1.0×1.0 cm square specimens, and soaked for 120 minutes in deionized water and 2M MgSO₄ solution, respectively. Then the leeching of plasticizer was determined by gravimetric analysis. The results are shown in Table V and FIG. 4.

TABLE V

% extractable

| Plasticizer | 2M MgSO₄ | DI H₄O |
|---|---|---|
| PPG425 | 3.7 | 10.0 |
| NP10 | 5.1 | 7.9 |
| NP8 | 1.4 | 32.3 |
| PEL35 | 4.4 | 48.6 |
| PEL42 | 6.4 | 34.5 |
| PEP1900 | 8.4 | 56.4 |
| PPE2000 | 19.4 | 57.5 |
| PEG600 | 18.7 | 34.3 |
| PErPP | 28.6 | 65.5 |

### EXAMPLE 7

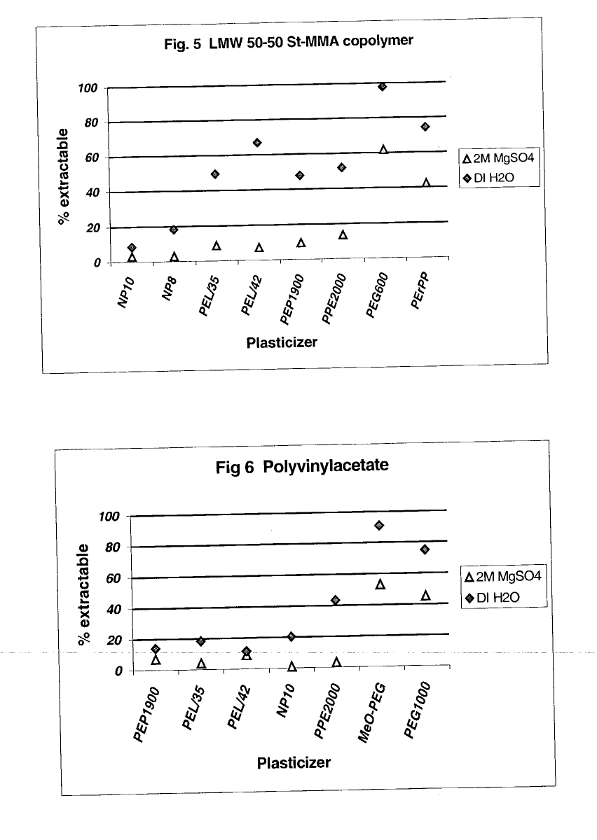

A 50/50 styrene/methyl methacrylate (St/MMA) copolymer was prepared in aqueous emulsion with about 35 percent solids. The molecular weight (Mn) was measured at about 25,000 by GPC. Blends of poly(St/MMA) and various plasticizers were made at 50/50 weight ratio. They were then made into films, as in Example 1. The films were cut into 1.0×1.0 cm square specimens, and soaked for 120 minutes in deionized water and 2M MgSO₄ solution, respectively. Then the leeching of plasticizer was determined by gravimetric analysis. The results are shown in Table VI and FIG. 5.

TABLE VI

% extractable

| Plasticizer | 2M MgSO₄ | DI H₂O |
|---|---|---|
| NP10 | 3.1 | 8.5 |
| NP8 | 3.0 | 18.3 |
| PEL/35 | 8.7 | 49.4 |
| PEL/42 | 7.2 | 67.0 |
| PEP1900 | 9.5 | 47.8 |
| PPE2000 | 13.6 | 51.9 |
| PEG600 | 61.7 | 97.9 |
| PErPP | 42.2 | 74.2 |

### EXAMPLE 8

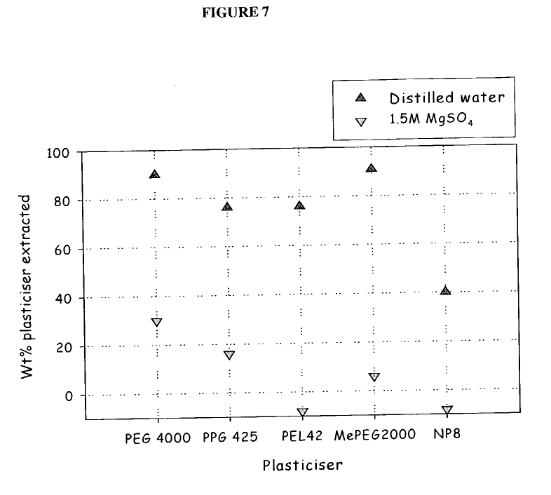

A commercial latex of polyvinylacetate contains 46 percent solids with Mn ranging from 22,000 to 55,000. Blends of the polyvinylacetate and plasticizers were made at 50/50 weight ratio. They were then made into films, as in Example 1. The films were cut into 1.0×1.0 cm square specimens, and soaked for 120 minutes in deionized water and 2M MgSO₄ solution, respectively. Then the leeching of plasticizer was determined by gravimetric analysis. The results are shown in Table VII and FIG. 6.

TABLE VII

% extractable

| Plasticizer | 2M MgSO₄ | DI H₂O |
|---|---|---|
| PEP1900 | 7.0 | 14.0 |
| PEL/35 | 4.0 | 18.4 |
| PEL/42 | 8.9 | 11.4 |
| NP10 | 0.9 | 20.2 |
| PPE2000 | 3.1 | 43.2 |
| MeO-PEG | 53.0 | 90.9 |
| PEG1000 | 45.2 | 74.8 |

### EXAMPLE 9

A 50/50 weight blend based on solids, of polymethylmethacrylate and Synperonic NP8, a nonyl phenol ethoxylate from Uniqema was used to prepare a film by drying at 120° C. for 30 minutes. The film was soaked in distilled water and 1 M NaCl solution for 60 minutes. After this period the level of NP8 leeched from the films was determined by gravimetric analysis. No significant leeching occurred from the film soaked in 1 M NaCl solution, and only 25 percent of the NP8 leeched from the film soaked in DI water. The slight loss of NP8 was not enough to trigger loss of integrity of the films.

### EXAMPLE 10

Blends of pMMA and polyethylene glycol derivatives were made at 50/50 weight percent. These were then made into films, as in Example 9, by drying the blends at 120° C. for 30 minutes. The films were soaked for 90 minutes in either distilled water or 1.5 M magnesium sulfate. The results are shown in Table I. PEG 4000 is a polyethylene glycol with a molecular weight of 4,000. PPG 425 is polypropylene glycol with a molecular weight of 425. PEL 42 is a block copolymer of ethylene oxide and propylene oxide with a molecular weight of 1200. MePEG2000 is a methoxy terminated polyethylene glycol with a molecular weight of 2000.

What is claimed is:

1. A polymer composition comprising
a) a polymer; and
b) at least one water-soluble, salt-sensitive adjuvant,
wherein said adjuvant affects the properties of a film formed from the polymer composition,
wherein said polymer composition is film-forming, and wherein a film formed from said polymer composition has integrity in an aqueous solution containing 0.5 weight percent or more of an inorganic salt, yet loses integrity in water due to the dissolution of the water-soluble adjuvant.

2. The polymer composition of claim 1 wherein said polymer is an emulsion polymer.

3. The polymer composition of claim 1 wherein said salt-sensitive adjuvant is selected from the group consisting of a plasticizer, adhesion promoter, tackifier, pigment, filler, and mixtures thereof.

4. The polymer composition of claim 3 wherein said plasticizer comprises a polyethylene glycol derivative.

5. The polymer composition of claim 1 wherein said adjuvant or adjuvants are present in the composition at from 1 to 300 parts per 100 parts of polymer on a solids weight percent.

6. A process for triggering a loss of integrity in a polymer film comprising the steps of
a) forming a polymer;
b) combining with said polymer at least one water-soluble, salt-sensitive adjuvant to form a salt-sensitive film-forming polymer composition, wherein said adjuvant affects the properties of a film formed from the emulsion polymer, wherein said polymer composition is film-forming, and wherein a film formed from said emulsion polymer has integrity in an aqueous solution containing 0.5 weight percent or more of an inorganic salt, yet loses integrity in Water due to the dissolution of the water-soluble adjuvant;
c) contacting said polymer composition with a substrate, and drying said polymer composition to form a film on said substrate;
d) placing said polymer film in an aqueous environment containing at least 0.5 weight percent of salt, wherein said film maintains its integrity; and
e) placing said polymer film in water, wherein said adjuvant leaches out of the film and the polymer film loses its integrity.

7. A substrate having applied directly thereon a polymer composition, wherein said polymer composition comprises
a) a polymer; and
b) at least one water-soluble, salt-sensitive adjuvant,
wherein said adjuvant affects the properties of a film formed from the polymer composition, wherein said polymer composition is film-forming, and wherein a film formed from said polymer composition has integrity in an aqueous solution containing 0.5 weight percent or more of an inorganic salt, yet loses integrity in water due to the dissolution of the water-soluble adjuvant.

8. The substrate of claim 7 wherein said substrate is a non-woven material

9. The substrate of claim 7 wherein said polymer comprises a continuous film covering one or more surfaces of said substrate.
